(19) United States
(12) Patent Application Publication
(10) Pub. No.: US 2011/0227313 A1
(43) Pub. Date: Sep. 22, 2011

(54) JIFFY STAND / KICK STAND HAVING ATTACHED PLATE

(76) Inventor: JACK BUTLER, Hamilton, OH (US)

(21) Appl. No.: 13/053,513

(22) Filed: Mar. 22, 2011

Related U.S. Application Data
(60) Provisional application No. 61/316,129, filed on Mar. 22, 2010.

(51) Int. Cl. B62H 7/00

(52) U.S. Cl. 280/293

(57) ABSTRACT

A coaster for a jack stand or kick stand may attach to the jack stand or kick stand of a motorcycle. The coaster may be bolted to the jack stand or kick stand, or, in some embodiments, the coaster may be attached to the jack stand or kick stand with a swivel mechanism. The stand-attached coaster may prevent the motorcycle from sinking into the ground when the motorcycle is parked on its Rick stand or jack stand. With the stand-attached coaster, there is no need to hold up the motorcycle to place a coaster stand. Instead, the user may simply lower the jiffy stand or kick stand and set the motorcycle.

### CROSS-REFERENCE TO RELATED APPLICATIONS

This application claims the benefit of priority of U.S. provisional patent application No. 61/316,129, filed Mar. 22, 2010, the contents of which are herein incorporated by reference.

### BACKGROUND OF THE INVENTION

The present invention relates to jiffy stands or kick stands for stand-supported equipment and, more particularly, to jiffy stands or kick stands having an attached plate.

Conventional kick stands or jiffy stands on motorcycles have a small elongated portion that contacts the ground. Often, the weight of the motorcycle will cause the stand to sink into the ground. To avoid this situation, riders often carry a coaster to place under the stand. To use such a coaster, the rider must, while holding up the motorcycle, place the coaster in the desired location and line up the stand with the coaster. When the rider wishes to leave, they must hold up the motorcycle, pick up the coaster and store the coaster before riding away.

As can be seen, there is a need for a jiffy stand or kick stand having a built-in coaster.

### SUMMARY OF THE INVENTION

In one aspect of the present invention, a stand-attached coaster for stand-supported equipment comprises a stand disposed between the stand-supported equipment and a supporting surface; a coaster plate attached to the stand and adapted to be disposed between the stand and the supporting surface when the stand-supported equipment is balanced by its stand.

In another aspect of the present invention, a stand-attached coaster for a motorcycle comprises a coaster plate attached to an end of a kick stand or a jiffy stand of the motorcycle.

These and other features, aspects and advantages of the present invention will become better understood with reference to the following drawings, description and claims.

### BRIEF DESCRIPTION OF THE DRAWINGS

FIG. 1 is a side view of a motorcycle with a stand-attached coaster according to an exemplary embodiment of the present invention;

FIG. 2 is a close-up view of the motorcycle of FIG. 1;

FIG. 3 is a perspective view of the stand-attached coaster of FIG. 1;

FIG. 4 is an exploded view of the stand-attached coaster of FIG. 1;

FIG. 5 is a front view of the stand-attached coaster of FIG. 1;

FIG. 6 is a side view of the stand-attached coaster of FIG. 1;

FIG. 7 is a perspective view of a stand-attached coaster according to another exemplary embodiment of the present invention; and

FIG. 8 is a cross-sectional view taken along line 8-8 of FIG. 7.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention provides a coaster for a jack stand or kick stand that may attach to the jack stand or kick stand. The coaster may be bolted to the jack stand or kick stand, or, in some embodiments, the coaster may be attached to the jack stand or kick stand with a swivel mechanism. The stand-attached coaster may prevent a bike, such as a motorcycle, from sinking into the ground when the bike is balanced on its kick stand or jack stand. With the stand-attached coaster, there is no need to hold up the motorcycle to place a coaster stand. Instead, the user may simply lower the jiffy stand or kick stand and set the motorcycle.

While the below Figures describe the use of the stand-attached coaster with a motorcycle, the stand-attached coaster may be used with any device that may rest on a kickstand. This may include, for example, bicycles and other machinery. As used herein, “stand-supported equipment” refers to devices that rest on a kick stand or jack stand. As used herein, “stand” may refer to a device adapted to support stand-supported equipment on a supporting surface, such as the ground. A stand may include a kick stand or a jack stand.

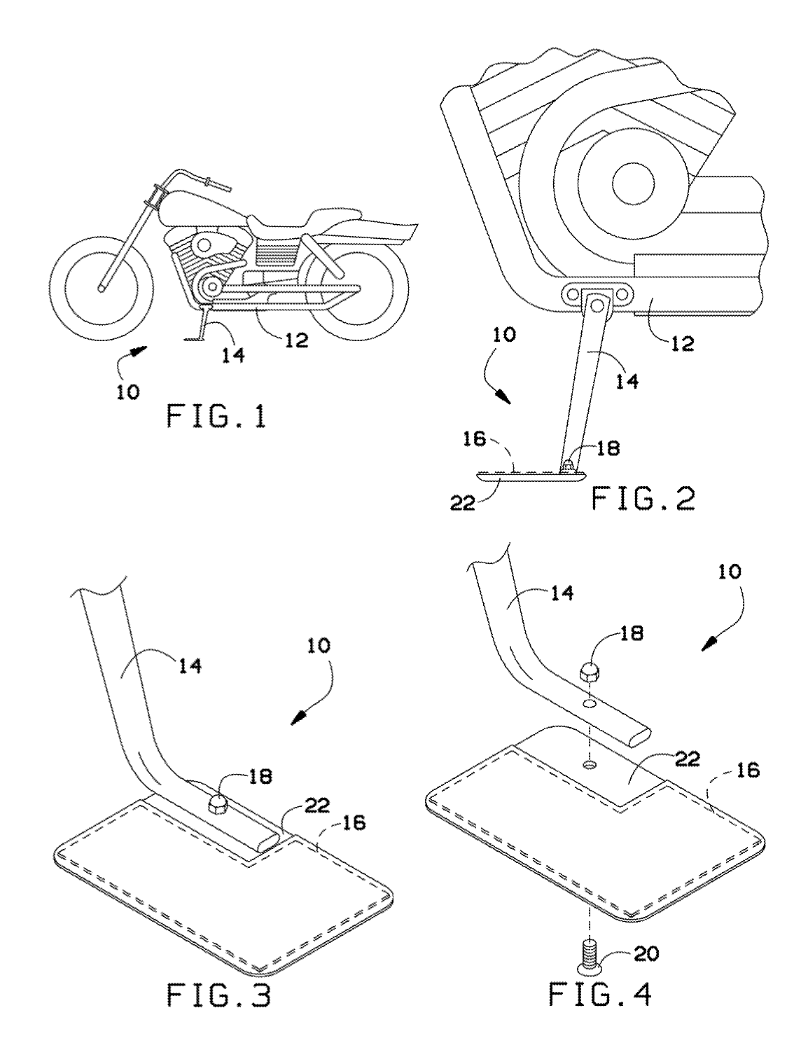

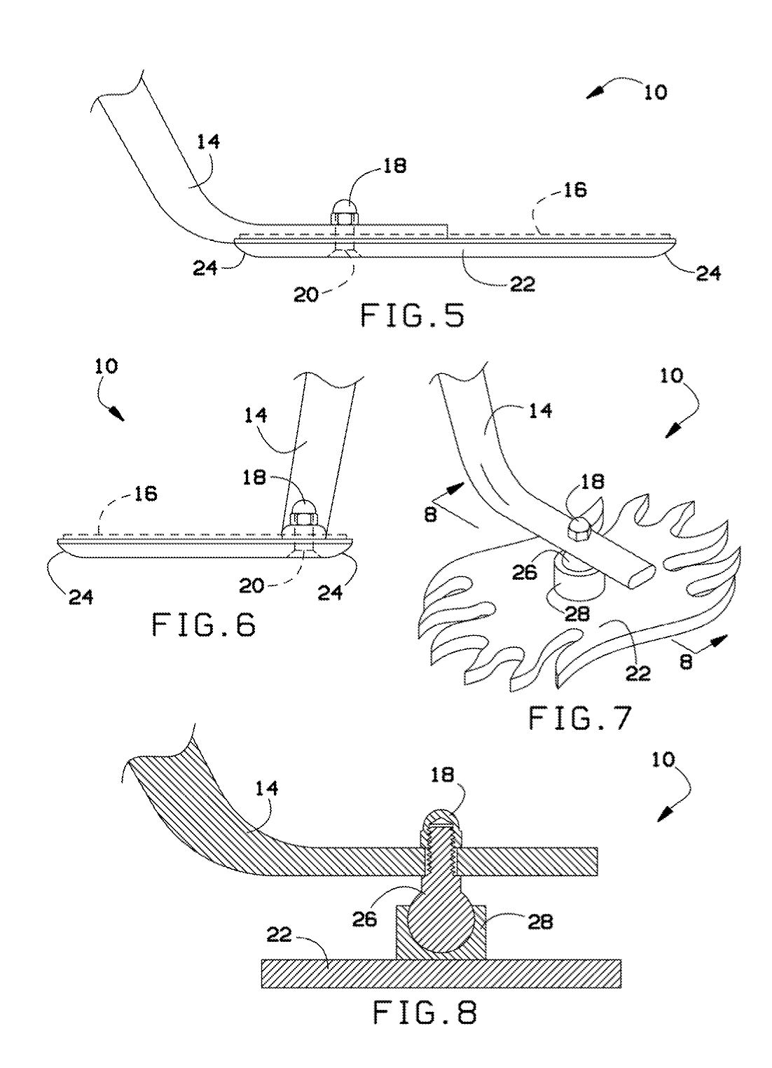

Referring to FIGS. 1 through 6, a stand-attached coaster 10 may include a coaster plate 22 that is adapted to attach to a stand 14 of stand-supported equipment, such as a motorcycle 12. The coaster plate 22 may be designed in various shapes and sizes. For example, the coaster plate 22 may be rectangular, square, circular, oval, or made into non-geometric shapes, such as flames, lightning bolts and the like. The coaster plate 22 may be from about 3 inches to about 10 inches in its various dimensions (such as length and width or diameter). For example, the coaster plate 22 may be a 6 inch circular shape or a 4 inch by 6 inch rectangular shape. The coaster plate 22 may be made of a rigid material, such as stainless steel, chrome-plated steel, or the like. The coaster plate 22 may be from about 3/16 inch to about ½ inch thick, typically about ¼ inch thick. The coaster plate 22 may include rounded edges 24 formed about a periphery of the coaster plate 22. The coaster plate 22 may include an area 16 for artwork, such as raised artwork, engravings, and the like.

In some embodiments, the coaster plate 22 may attach to the stand 14 near an edge of the coaster plate 22, as shown in FIG. 3. In other embodiments, the coaster plate 22 may attach to the stand 14 in a central portion of the coaster plate 22. The coaster plate 22 may be attached to the stand 14 by, for example, passing a flat head screw 20 through holes in the coaster plate 22 and stand 14 and securing the coaster plate 22 to the stand 14 with a nut 18, typically a cap/acorn nut. The use of a flat head screw 20 may result in a clean, even underside (ground contacting side) of the coaster plate 22 when the screw 20 is used in a recessed hole. In some embodiments, the coaster plate 22 may be permanently affixed to the stand 14, for example, by welding.

Referring now to FIGS. 7 and 8, the stand 14 may be attached to the coaster plate 22 with a swivel ball 26 and swivel socket 28. A swivel plate design may be beneficial to certain motorcycles where a fixedly-attached plate (as described above with reference to FIGS. 1 through 6) may not be suitably disposed for riding when the stand is up.

The swivel ball 26 may attach to the stand 14 by inserting a threaded end of the swivel ball 26 through a hole in the stand 14 and securing the swivel ball 26 to the stand 14 with the cap/acorn nut 18. The swivel socket 28 may be attached to the coaster plate 22 and may be adapted to secure a ball end of the swivel ball 26, allowing the coaster plate 22 to swivel relative to the stand 14.

It should be understood, of course, that the foregoing relates to exemplary embodiments of the invention and that modifications may be made without departing from the spirit and scope of the invention as set forth in the following claims.

What is claimed is:

1. A stand-attached coaster for stand-supported equipment, the stand-attached coaster comprising:
a stand disposed between the stand-supported equipment and a supporting surface;
a coaster plate attached to the stand and adapted to be disposed between the stand and the supporting surface when the stand-supported equipment is balanced by its stand.

2. The stand-attached coaster of claim 1, wherein the stand-supported equipment is a motorcycle and the stand is a jack stand or a kick stand.

3. The stand-attached coaster of claim 1, wherein the stand is fixedly attached to the coaster plate.

4. The stand-attached coaster of claim 3, wherein the stand is attached near an edge of the coaster plate.

5. The stand-attached coaster of claim 1, wherein the stand is attached to the coaster plate with a swivel mechanism.

6. The stand-attached coaster of claim 5, further comprising:
a swivel ball attached to the stand; and
a swivel socket attached to the coaster plate.

7. The stand-attached coaster of claim 1, further comprising an artwork area on one side of the stand, the artwork area facing the stand-supported equipment when the stand-supported equipment is balanced on the stand.

8. The stand-attached coaster of claim 1, wherein the coaster plate has rounded edges about a periphery thereof.

9. A stand-attached coaster for a motorcycle, comprising:
a coaster plate attached to an end of a kick stand or a jiffy stand of the motorcycle.

10. The stand-attached coaster of claim 9, wherein the coaster plate is either fixedly attached to the kick stand or jiffy stand, or the coaster plate is attached to the kick stand or jiffy stand with a swivel mechanism.
